(19) United States
(12) Patent Application Publication
(10) Pub. No.: US 2024/0378517 A1
(43) Pub. Date: Nov. 14, 2024

(54) Auto-Generation of Personalized Context-Dependent Task Resumption Memory Cues

(71) Applicant: International Business Machines Corporation, Armonk, NY (US)

(72) Inventors: Julian Bertram Kuehnert, Nairobi (KE); William Ogallo, Nairobi (KE); Nelson Kibichii Bore, Lessos (KE); Charles Muchiri Wachira, Karatina (KE); Isaiah Mulang' Onando, Nairobi (KE); Sekou Lionel Remy, Nairobi (KE); Aisha Walcott, Nairobi (KE)

(21) Appl. No.: 18/315,611

(22) Filed: May 11, 2023

(51) Int. Cl. G06Q 10/0631; G06N 20/00; G06Q 10/0639

(52) U.S. Cl. CPC G06Q 10/063114; G06N 20/00; G06Q 10/06395; G06Q 10/1097

(57) ABSTRACT

Context-dependent memory stimulation is provided. A context-dependent task resumption memory cue personalized to a user is sent to a client device of the user via a network during a task interruption lag period corresponding to a primary task prior to the user starting a set of secondary tasks to support a context-dependent memory of the user associated with the primary task. It is determined that the user started and then stopped performing the set of secondary tasks based on monitoring the client device. The context-dependent task resumption memory cue personalized to the user is resent to the client device via the network during a task resumption lag period corresponding to the primary task to stimulate the context-dependent memory of the user associated with the primary task in response to the computer determining that the user stopped performing the set of secondary tasks and resumed the primary task.

### BACKGROUND

The disclosure relates generally to memory and more specifically to automatically generating personalized context-dependent task resumption memory cues to regain the context of an interrupted task.

An increasing number of people rely on virtual or hybrid workplaces because of an ability to perform work remotely (e.g., working from home, collaborating in a global lab network, performing job duties remotely such as IT technician, software engineer, program modeler, and the like). Furthermore, many tasks, such as software coding in an integrated development environment, cannot be completed in just one session as other tasks, such as scheduled video conference meetings, may interrupt the primary task of a user. Such primary task interruptions increase the likelihood of user errors, negative user emotions, decreased user time spent on the primary task, and the like.

### SUMMARY

According to one illustrative embodiment, a computer-implemented method for context-dependent memory stimulation is provided. A computer sends a context-dependent task resumption memory cue personalized to a user to a client device of the user via a network during a task interruption lag period corresponding to a primary task prior to the user starting a set of secondary tasks to support a context-dependent memory of the user associated with the primary task. The computer determines that the user started performing the set of secondary tasks based on monitoring the client device. The computer determines that the user stopped performing the set of secondary tasks based on the monitoring of the client device. The computer resends the context-dependent task resumption memory cue personalized to the user to the client device via the network during a task resumption lag period corresponding to the primary task to stimulate the context-dependent memory of the user associated with the primary task in response to the computer determining that the user stopped performing the set of secondary tasks and resumed the primary task. According to other illustrative embodiments, a computer system and computer program product for context-dependent memory stimulation are provided.

### BRIEF DESCRIPTION OF THE DRAWINGS

FIG. 1 is a pictorial representation of a computing environment in which illustrative embodiments may be implemented;

FIG. 2 is a diagram illustrating an example of a context-dependent task resumption memory cue management system in accordance with an illustrative embodiment;

FIG. 3 is a diagram illustrating an example of an actor-critic reinforcement learning model in accordance with an illustrative embodiment;

FIG. 4 is a diagram illustrating an example of a context-dependent task resumption memory cue management process in accordance with an illustrative embodiment; and

FIGS. 5A-5C are a flowchart illustrating a process for managing personalized context-dependent task resumption memory cues for improved task resumption in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

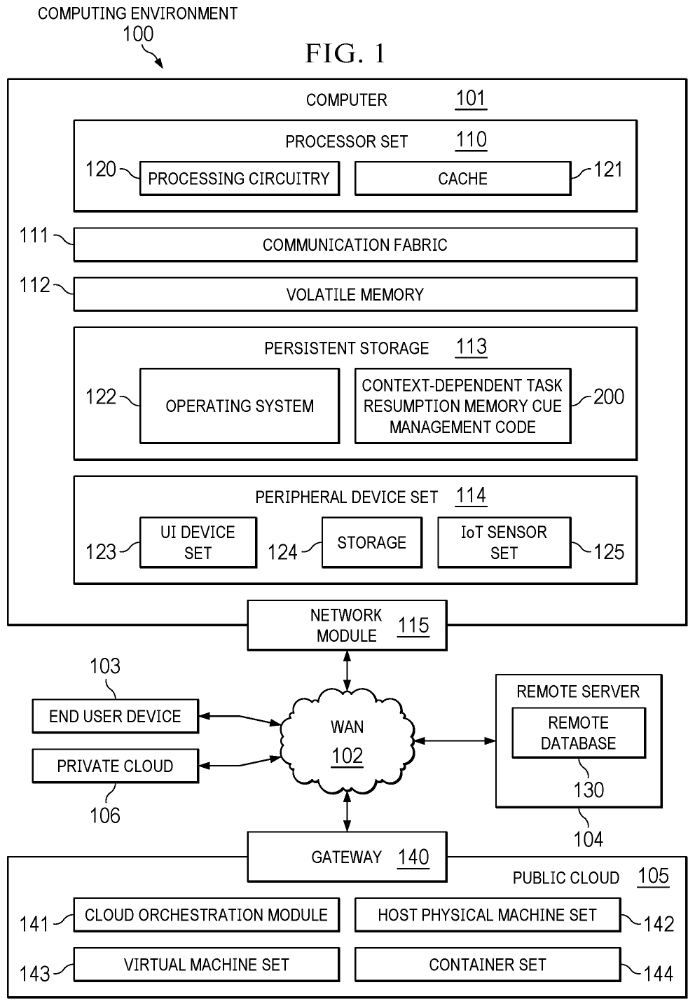

With reference now to the figures, and in particular, with reference to FIGS. 1-4, diagrams of data processing environments are provided in which illustrative embodiments may be implemented. It should be appreciated that FIGS. 1-4 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as context-dependent task resumption memory cue management code 200. For example, context-dependent task resumption memory cue management code 200 optimizes generated task resumption memory cues for users iteratively across task interruption and task resumption periods. Context-dependent task resumption memory cue management code 200 utilizes reinforcement learning based on user evaluation feedback and other quantitative metrics regarding the effectiveness of these generated task resumption memory cues for memory cue optimization. Context-dependent task resumption memory cue management code 200 provides automated generation and optimization of these personalized context-dependent task resumption memory cues for efficient task resumption by users across a multitude of different tasks. Context-dependent task resumption memory cue management code 200 automatically generates these personalized context-dependent task resumption memory cues prior to the interruption of a primary task (i.e., a task interruption lag period) and outputs these same personalized context-dependent task resumption memory cues after the user completed a set of one or more secondary tasks (i.e., a task resumption lag period) in order for the user to regain the task context to resume the primary task.

In addition to context-dependent task resumption memory cue management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and context-dependent task resumption memory cue management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, mainframe computer, quantum computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in context-dependent task resumption memory cue management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The context-dependent task resumption memory cue management code included in block 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (for example, a customer of the context-dependent task resumption memory cue management service provided by computer 101), and may take any of the forms discussed above in connection with computer 101. EUD 103 typically receives helpful and useful data from the operations of computer 101. For example, in a hypothetical case where computer 101 is designed to provide a context-dependent task resumption memory cue to the end user, this context-dependent task resumption memory cue would typically be communicated from network module 115 of computer 101 through WAN 102 to EUD 103. In this way, EUD 103 can display, or otherwise present, the context-dependent task resumption memory cue to the end user. In some embodiments, EUD 103 may be a client device, such as thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a context-dependent task resumption memory cue based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The human brain needs a certain amount of time when switching between different tasks to refocus on the task at hand. In other words, a user needs a certain amount of time (e.g., a task resumption lag period) to totally regain the task context when resuming an interrupted task. Furthermore, switching to another task in the middle of an ongoing complex task halts and hinders task productivity. Context-dependent memory of a user can be supported with stimuli. For example, a user can retrieve the context of an interrupted task with the help of memory priming using a task resumption memory cue.

Currently, monitoring the impact of task interruptions and ameliorations has involved resource and time intensive data collection and analysis in experimental settings oftentimes with few participants. Such current solutions are not readily scalable to large entities, such as, for example, enterprises, businesses, companies, organizations, institutions, agencies, or the like.

Illustrative embodiments automatically generate personalized context-dependent task resumption memory cues for users in virtual workplaces to minimize the detrimental effects of task interruptions. For example, illustrative embodiments predict the likelihood of interruptions of ongoing primary tasks by certain events, such as video conference meetings, that are scheduled on electronic calendars of users. The personalized context-dependent task resumption memory cues of illustrative embodiments include generated audio cues based on the context of the ongoing primary tasks. Illustrative embodiments evaluate the effectiveness of these auto-generated personalized context-dependent task resumption memory cues in reducing the task resumption lag period as well as the quality of the memorized entity.

Illustrative embodiments automatically generate the personalized context-dependent task resumption memory cues for users prior to interruption of a primary task (i.e., during the task interruption lag period) to support the context-dependent memory of a user and output the same personalized context-dependent task resumption memory cues after the user completed a set of one or more secondary tasks (i.e., during the task resumption lag period) to simulate the context-dependent memory of the user in order for the user to fully recall and regain the context of the primary task for primary task resumption. Illustrative embodiments evaluate the effectiveness of generated personalized context-dependent task resumption memory cues corresponding to a particular user against the quality of task resumption using quantitative metrics and qualitative metrics and evolve the personalized context-dependent task resumption memory cues of that particular user over time as illustrative embodiments learn and optimize the personalized context-dependent task resumption memory cues using a machine learning model, such as, for example, a reinforcement learning model. By utilizing an artificial intelligence audio synthesizer to synthesize audio cues, illustrative embodiments can generate a multitude of unique audio cues, which are characterized by a certain genre or mood and adopted for each particular task and context. Illustrative embodiments can separate different tasks and different contexts in the perception space of a user by using the different audio cue genres or moods.

Thus, illustrative embodiments provide one or more technical solutions that overcome a technical problem of how to stimulate the context-dependent memory of a user to quickly regain the context of an interrupted task after interruption as for example by performing another task. Task interruption can also be due to end of working day hours, weekends, or the like. Alternatively, the user may resume the task after one week as the user chooses to work on that specific task, for example, once a week. As a result, these one or more technical solutions provide a technical effect and practical application in the field of memory stimulation.

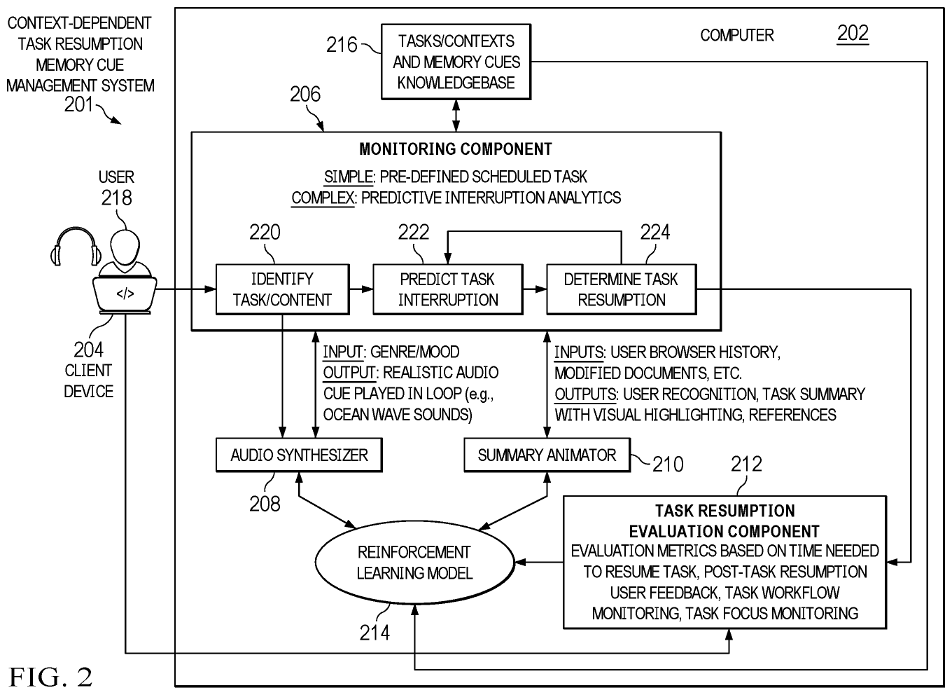

With reference now to FIG. 2, a diagram illustrating an example of a context-dependent task resumption memory cue management system is depicted in accordance with an illustrative embodiment. Context-dependent task resumption memory cue management system 201 may be implemented in a computing environment, such as computing environment 100 in FIG. 1. Context-dependent task resumption memory cue management system 201 is a system of hardware and software components for automatically generating personalized context-dependent task resumption memory cues for users to regain the context of interrupted tasks after performing other tasks.

In this example, context-dependent task resumption memory cue management system 201 includes computer 202 and client device 204. Computer 202 and client device 204 may be, for example, computer 101 and EUD 103, respectively, in FIG. 1. However, it should be noted that context-dependent task resumption memory cue management system 201 is intended as an example only and not as a limitation on illustrative embodiments. For example, context-dependent task resumption memory cue management system 201 can include any number of computers, client devices, and other devices and components not shown.

In this example, computer 202 includes monitoring component 206, audio synthesizer 208, summary animator 210, task resumption evaluation component 212, reinforcement learning model 214, and tasks/contexts and memory cues knowledgebase 216. Monitoring component 206, audio synthesizer 208, summary animator 210, task resumption evaluation component 212, reinforcement learning model 214, and tasks/contexts and memory cues knowledgebase 216 may be implemented by, for example, context-dependent task resumption memory cue management code 200 in FIG. 1.

Computer 202 utilizes monitoring component 206 to, for example, monitor browser tabs and online activity of user 218 as user 218 utilizes client device 204, monitor documents opened and closed by user 218 on client device 204, monitor modifications to documents by user 218 on client device 204, monitor commits made by user 218 in a version control system using client device 204, monitor electronic calendar entries for scheduled meetings, events, activities, and the like corresponding to user 218, predict task interruption based on electronic calendar entries, output audio cues and animated task summaries received from audio synthesizer 208 and summary animator 210 prior to task interruption and task resumption, monitor for task resumption by user 218 on client device 204, and the like.

Computer 202 utilizes audio synthesizer 208 to generate a multitude of unique audio cues to support and stimulate the context-dependent memory of user 218 regarding given tasks using different audio genres or moods. Audio synthesizer 208 may be, for example, an automated artificial intelligence audio synthesizer. Audio synthesizer outputs audio cues (e.g., ocean wave sounds) to monitoring component 206, which monitoring component 206 can play in a loop for user 218 to support and stimulate the context-dependent memory of user 218 to fully remember and regain the context of an interrupted task.

Computer 202 utilizes summary animator 210 to generate an animated summary of the task that monitoring component 206 predicts will be interrupted. Summary animator 210 can receive inputs, such as, for example, browser history, modified document history, modified document line history, and the like corresponding to user 218, from monitoring component 206. Then, summary animator 210 outputs, for example, user recognition such as “Hurray, look at your achievement on this task!! You worked on . . . ”) using an artificial intelligence voice generator, an animated summary of the task with visual highlighting such as bolding, italicizing, or underlining of different portions of the summary, a list of references corresponding to the task that user 218 previously referred to, and the like.

Computer 202 utilizes tasks/contexts and memory cue knowledgebase 216, implemented for example as a knowledge graph, as a library of all current ongoing tasks and their corresponding contexts, along with the personalized set of context-dependent task resumption memory cues associated with each respective user (e.g., user 218). In other words, tasks/contexts and memory cue knowledgebase 216 stores all the information needed for user task resumption and to ensure that audio cues corresponding to different tasks do not conflict (i.e., confuse the user as to which task context the user wants to remember). Tasks/contexts and memory cue knowledgebase 216 abstracts personalized context-dependent task resumption memory cues by genre or mood. Tasks/contexts and memory cue knowledgebase 216 maps context by affinity in terms of content using, for example, Kullback-Leibler distance. Tasks/contexts and memory cue knowledgebase 216 maps audio cues by affinity in terms of genre or mood (e.g., similar tasks, related tasks, or tasks related to the same activity can have same or similar audio cues).

Computer 202 utilizes task resumption evaluation component 212 to determine how well user 218 resumed the primary task upon completion of the set of secondary tasks. Task resumption evaluation component 212 utilizes quantitative metrics and qualitative metrics to make the determination as to how well user 218 resumed the primary task. The quantitative metrics include, for example, task resumption metrics, task focus metrics, and the like. The task resumption metrics and task focus metrics include, for example, the total amount of time needed by user 218 to actually resume the primary task, how many times user 218 needed to go back and forth between browser tabs, documents, references, and the like to finally regain the full context of the primary task, how many times user 218 switched between task-related activities and non-task-related activities, and the like. The qualitative metrics include, for example, feedback from user 218 regarding how quickly user 218 regained the context of the primary task, confirmation from user 218 as to whether user 218 feels that the primary task is fully resumed, and the like.

At 220, monitoring component 206 identifies an ongoing primary task and a context of the ongoing primary task when user 218 starts to perform the ongoing primary task on client device 204. In addition, monitoring component 206 monitors a task workflow of the ongoing primary task. At 222, monitoring component 206 utilizes the information in the task workflow to predict the likelihood of an upcoming interruption of the ongoing primary task. If the likelihood of an upcoming interruption of the ongoing primary task is greater than a defined likelihood threshold level, then monitoring component 206 estimates the start and duration of the task interruption lag period and generates a personalized context-dependent task resumption memory cue for user 218 using an audio cue generated by audio synthesizer 208 and an animated task summary of the ongoing primary task with visual highlighting of portions of the task summary generated by summary animator 210.

In response to generating the personalized context-dependent task resumption memory cue, monitoring component 206 outputs the personalized context-dependent task resumption memory cue on client device 204 prior to user 218 performing a set of secondary tasks on user device 204 to support the context-dependent memory of user 218 associated with the ongoing primary task. Monitoring component 206 monitors a task workflow of the set of secondary tasks to predict the start and duration of the task resumption lag period. During the task resumption lag period, monitoring component 206 outputs the same personalized context-dependent task resumption memory cue used during the task interruption lag period on client device 204 to stimulate the context-dependent memory of user 218 to regain the context of the ongoing primary task. At 224, monitoring component 206 determines task resumption of the ongoing primary task. In response to determining that user 218 has fully resumed the ongoing primary task, computer 202 utilizes reinforcement learning model 214 to evaluate the effectiveness of the personalized context-dependent task resumption memory cue. Computer 202 stores the result of the evaluation of the effectiveness of the personalized context-dependent task resumption memory cue in tasks/contexts and memory cues knowledgebase 216.

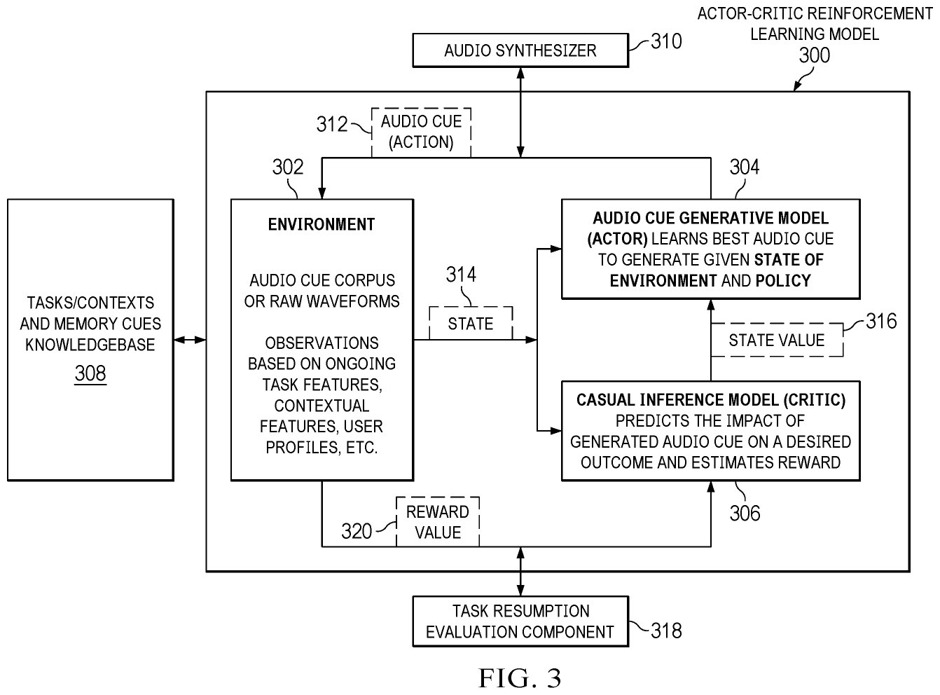

With reference now to FIG. 3, a diagram illustrating an example of an actor-critic reinforcement learning model is depicted in accordance with an illustrative embodiment. Actor-critic reinforcement learning model 300 may be, for example, reinforcement learning model 214 of computer 202 in FIG. 2. In addition, actor-critic reinforcement learning model 300 may be implemented by, for example, context-dependent task resumption memory cue management code 200 in FIG. 1.

Illustrative embodiments utilize actor-critic reinforcement learning model 300 to continually optimize the audio cue generation process. In this example, actor-critic reinforcement learning model 300 includes environment 302, audio cue generative model 304 (i.e., the actor), and causal inference model 306 (i.e., the critic).

Environment 302 is coupled to tasks/contexts and memory cues knowledgebase 308, such as, for example, tasks/contexts and memory cues knowledgebase 216 in FIG. 2. Environment 302 comprises a large-scale audio cue corpus and/or raw audio waveform data. Environment 302 also comprises observations based on features derived from ongoing tasks, their corresponding contexts, electronic calendar entries, and the like.

Audio cue generative model 304 is coupled to audio synthesizer 310, such as, for example, audio synthesizer 208 in FIG. 2. Audio cue generative model 304 directs audio synthesizer 310 to generate a unique audio memory cue (i.e., audio cue 312), which is personalized for a user, such as, for example, user 218 in FIG. 2, based on learning from the audio cue corpus, raw audio waveforms, or other audio representations of environment 302 while taking into account state 314 (i.e., task context) of environment 302. Audio cue generative model 304 optimizes audio cue 312 by sampling audio cues using a policy gradient function that provides an updated output (i.e., state value 316) from causal inference model 306.

Causal inference model 306 is coupled to task resumption evaluation component 318, such as, for example, task resumption evaluation component 212 in FIG. 2. Causal inference model 306 computes state value 316 corresponding to a given state of environment 302. Causal inference model 306 predicts the effectiveness of audio cue 312 based on a specified outcome (e.g., duration of the task resumption lag period), while accounting for confounding factors by other contextual features. Actor-critic reinforcement learning model 300 utilizes the output of causal inference model 306 to compute reward value 320, which actor-critic reinforcement learning model 300 utilizes to update the policy gradient function of audio cue generative model 304.

It should be noted that when audio synthesizer 310 generates a new audio cue, environment 302 enters a new state. Then, causal inference model 306 evaluates the effectiveness of the newly generated audio cue on an outcome of interest (e.g., duration of the task resumption lag period) and generates a new reward value. Furthermore, audio cue generative model 304 updates its parameters using the policy gradient function.

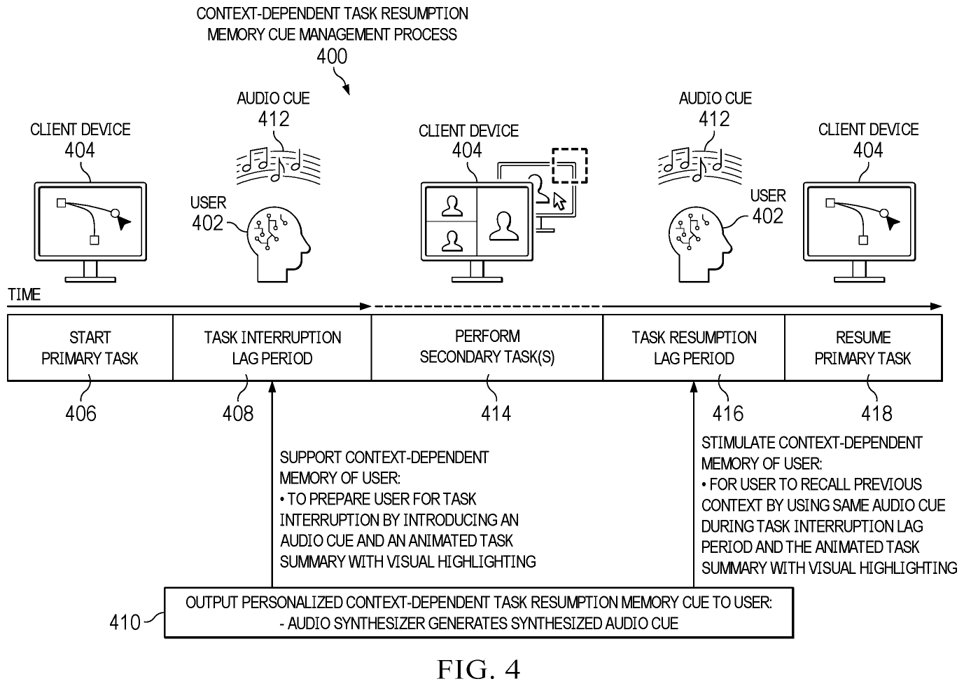

With reference now to FIG. 4, a diagram illustrating an example of a context-dependent task resumption memory cue management process is depicted in accordance with an illustrative embodiment. Context-dependent task resumption memory cue management process 400 can be implemented in a computing environment, such as, for example, computing environment 100 in FIG. 1 or context-dependent task resumption memory cue management system 201 in FIG. 2.

In this example, context-dependent task resumption memory cue management process 400 involves user 402 and client device 404. However, it should be noted that context-dependent task resumption memory cue management process 400 is intended as an example only and not as a limitation on illustrative embodiments. For example, context-dependent task resumption memory cue management process 400 can involve any number of users and client devices.

At 406, user 402 starts a primary task on client device 404. A computer, such as, for example, computer 202 in FIG. 2, monitors a task workflow of the primary task on client device 404. Based on monitoring the task workflow of the primary task, the computer predicts that the primary task will be interrupted due to, for example, a scheduled meeting on an electronic calendar of user 402. As a result, the computer determines the start and duration of task interruption lag period 408.

At 410, the computer outputs a personalized context-dependent task resumption memory cue on client device 404 for user 402 during task interruption lag period 408 to support the context-dependent memory of user 402 to prepare user 402 for interruption of the primary task. The personalized context-dependent task resumption memory cue includes audio cue 412 and an animated task summary with visual highlighting. The computer utilizes an audio synthesizer, such as, for example, audio synthesizer 208 in FIG. 2, to generate audio cue 412. The computer utilizes a summary animator, such as, for example, summary animator 210 in FIG. 2, to generate the animated task summary with visual highlighting.

At 414, the computer determines that user 402 is now performing a set of one or more secondary tasks on client device 404. Subsequently, the computer determines that user 402 stopped performing the set of secondary tasks. In response to determining that user 402 stopped performing the set of secondary tasks, the computer again outputs the same personalized context-dependent task resumption memory cue on client device 404 for user 402 during task resumption lag period 416 to stimulate the context-dependent memory of user 402 for user 402 to recall the context of the primary task for resumption of the primary task. At 418, user 402 fully resumes the primary task on client device 404.

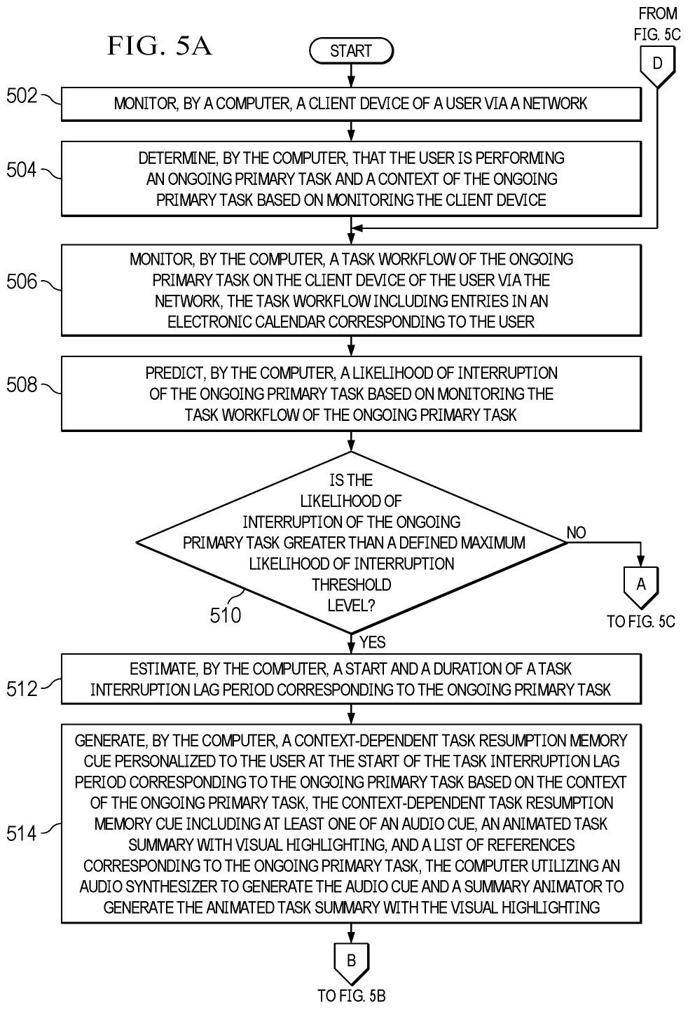

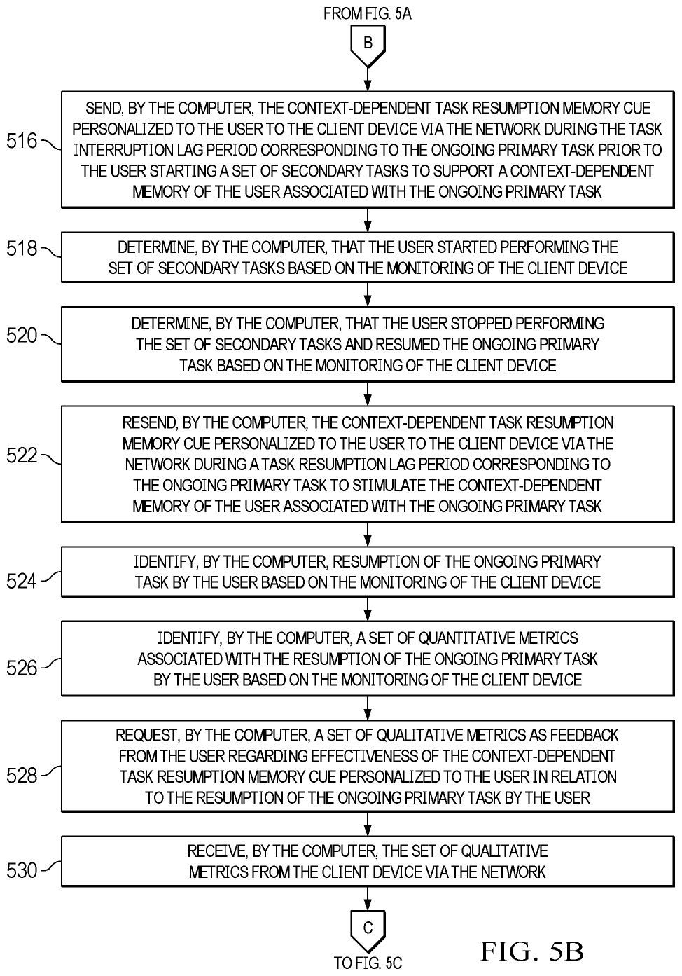

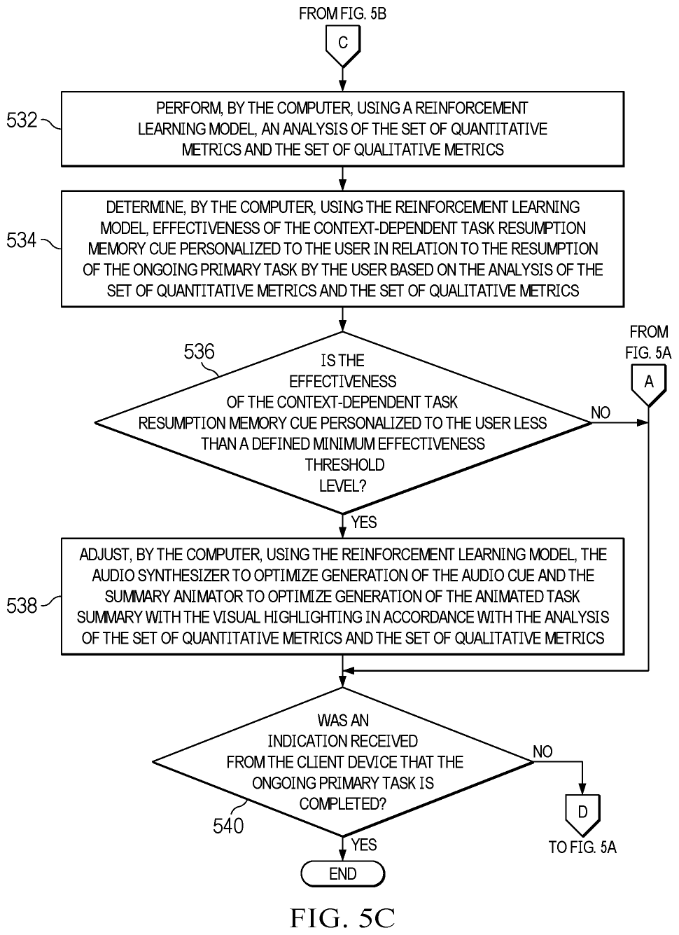

With reference now to FIGS. 5A-5C, a flowchart illustrating a process for managing personalized context-dependent task resumption memory cues for improved task resumption is shown in accordance with an illustrative embodiment. The process shown in FIGS. 5A-5C may be implemented in a computer, such as, for example, computer 101 in FIG. 1 or computer 202 in FIG. 2. For example, the process shown in FIGS. 5A-5C may be implemented in context-dependent task resumption memory cue management code 200 in FIG. 1.

The process begins when the computer monitors a client device of the user via a network (step 502). The computer determines that the user is performing an ongoing primary task and determines a context of the ongoing primary task based on monitoring the client device (step 504). In response to determining that the user is performing the ongoing primary task, the computer monitors a task workflow of the ongoing primary task on the client device of the user via the network (step 506). The task workflow includes entries (e.g., scheduled meeting, activities, events, and the like) in an electronic calendar corresponding to the user.

The computer predicts a likelihood of interruption of the ongoing primary task based on monitoring the task workflow of the ongoing primary task (step 508). The computer makes a determination as to whether the likelihood of interruption of the ongoing primary task is greater than a defined maximum likelihood of interruption threshold level (step 510). If the computer determines that the likelihood of interruption of the ongoing primary task is not greater than the defined maximum likelihood of interruption threshold level, no output of step 510, then the process proceeds to step 540. If the computer determines that the likelihood of interruption of the ongoing primary task is greater than the defined maximum likelihood of interruption threshold level, yes output of step 510, then the computer estimates a start and a duration of a task interruption lag period corresponding to the ongoing primary task (step 512).

In response to estimating the start and the duration of the task interruption lag period corresponding to the ongoing primary task, the computer generates a context-dependent task resumption memory cue personalized to the user at the start of the task interruption lag period corresponding to the ongoing primary task based on the context of the ongoing primary task (step 514). The context-dependent task resumption memory cue includes at least one of an audio cue, an animated task summary with visual highlighting, and a list of references corresponding to the ongoing primary task. The computer utilizes an audio synthesizer to generate the audio cue and a summary animator to generate the animated task summary with the visual highlighting.

The computer sends the context-dependent task resumption memory cue personalized to the user to the client device via the network during the task interruption lag period corresponding to the ongoing primary task prior to the user starting a set of secondary tasks to support a context-dependent memory of the user associated with the ongoing primary task (step 516). Subsequently, the computer determines that the user started performing the set of secondary tasks based on the monitoring of the client device (step 518). Afterward, the computer determines that the user stopped performing the set of secondary tasks and resumed the ongoing primary task based on the monitoring of the client device (step 520).

In response to determining that the user stopped performing the set of secondary tasks and resumed the ongoing primary task, the computer resends the context-dependent task resumption memory cue personalized to the user to the client device via the network during a task resumption lag period corresponding to the ongoing primary task to stimulate the context-dependent memory of the user associated with the ongoing primary task (step 522). In addition, the computer identifies resumption of the ongoing primary task by the user based on the monitoring of the client device (step 524). Further, the computer identifies a set of quantitative metrics associated with the resumption of the ongoing primary task by the user based on the monitoring of the client device (step 526).

Furthermore, the computer requests a set of qualitative metrics as feedback from the user regarding effectiveness of the context-dependent task resumption memory cue personalized to the user in relation to the resumption of the ongoing primary task by the user (step 528). Subsequently, the computer receives the set of qualitative metrics from the client device via the network (step 530). The computer, using a reinforcement learning model, performs an analysis of the set of quantitative metrics and the set of qualitative metrics (step 532).

The computer, using the reinforcement learning model, determines effectiveness of the context-dependent task resumption memory cue personalized to the user in relation to the resumption of the ongoing primary task by the user based on the analysis of the set of quantitative metrics and the set of qualitative metrics (step 534). The computer makes a determination as to whether the effectiveness of the context-dependent task resumption memory cue personalized to the user is less than a defined minimum effectiveness threshold level (step 536). If the computer determines that the effectiveness of the context-dependent task resumption memory cue personalized to the user is not less than the defined minimum effectiveness threshold level, no output of step 536, then the process proceeds to step 540. If the computer determines that the effectiveness of the context-dependent task resumption memory cue personalized to the user is less than the defined minimum effectiveness threshold level, yes output of step 536, then the computer, using the reinforcement learning model, adjusts the audio synthesizer to optimize generation of the audio cue and the summary animator to optimize generation of the animated task summary with the visual highlighting in accordance with the analysis of the set of quantitative metrics and the set of qualitative metrics (step 538).

Afterward, the computer makes a determination as to whether an indication was received from the client device that the ongoing primary task is completed (step 540). If the computer determines that no indication was received from the client device that the ongoing primary task is completed, no output of step 540, then the process returns to step 506 where the computer continues to monitor the task workflow of the ongoing primary task. If the computer determines that the indication was received from the client device that the ongoing primary task is completed, yes output of step 540, then the process terminates thereafter.

Thus, illustrative embodiments of the present disclosure provide a computer-implemented method, computer system, and computer program product for automatically generating personalized context-dependent task resumption memory cues for users to regain the context of an interrupted task after preforming a set of other tasks. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for context-dependent memory stimulation, the computer-implemented method comprising:
sending, by a computer, a context-dependent task resumption memory cue personalized to a user to a client device of the user via a network during a task interruption lag period corresponding to a primary task prior to the user starting a set of secondary tasks to support a context-dependent memory of the user associated with the primary task;
determining, by the computer, that the user started performing the set of secondary tasks based on monitoring the client device;
determining, by the computer, that the user stopped performing the set of secondary tasks and resumed the primary task based on the monitoring of the client device; and
resending, by the computer, the context-dependent task resumption memory cue personalized to the user to the client device via the network during a task resumption lag period corresponding to the primary task to stimulate the context-dependent memory of the user associated with the primary task in response to the computer determining that the user stopped performing the set of secondary tasks and resumed the primary task.

2. The computer-implemented method of claim 1, further comprising:
identifying, by the computer, resumption of the primary task by the user based on the monitoring of the client device; and
identifying, by the computer, a set of quantitative metrics associated with the resumption of the primary task by the user based on the monitoring of the client device.

3. The computer-implemented method of claim 2, further comprising:
requesting, by the computer, a set of qualitative metrics as feedback from the user regarding effectiveness of the context-dependent task resumption memory cue personalized to the user in relation to the resumption of the primary task by the user; and
receiving, by the computer, the set of qualitative metrics from the client device via the network.

4. The computer-implemented method of claim 3, further comprising:
performing, by the computer, using a reinforcement learning model, an analysis of the set of quantitative metrics and the set of qualitative metrics; and
determining, by the computer, using the reinforcement learning model, effectiveness of the context-dependent task resumption memory cue personalized to the user in relation to the resumption of the primary task by the user based on the analysis of the set of quantitative metrics and the set of qualitative metrics.

5. The computer-implemented method of claim 4, further comprising:
determining, by the computer, whether the effectiveness of the context-dependent task resumption memory cue personalized to the user is less than a defined minimum effectiveness threshold level; and
adjusting, by the computer, using the reinforcement learning model, an audio synthesizer to optimize generation of an audio cue and a summary animator to optimize generation of an animated task summary with visual highlighting in accordance with the analysis of the set of quantitative metrics and the set of qualitative metrics.

6. The computer-implemented method of claim 1, further comprising:
monitoring, by the computer, the client device of the user via the network:
determining, by the computer, that the user is performing the primary task and a context of the primary task based on the monitoring of the client device; and
monitoring, by the computer, a task workflow of the primary task on the client device of the user via the network in response to the computer determining that the user is performing the primary task, wherein the task workflow includes entries in an electronic calendar corresponding to the user.

7. The computer-implemented method of claim 6, further comprising:
predicting, by the computer, a likelihood of interruption of the primary task based on the monitoring of the task workflow of the primary task;
determining, by the computer, whether the likelihood of interruption of the primary task is greater than a defined maximum likelihood of interruption threshold level; and
estimating, by the computer, a start and a duration of the task interruption lag period corresponding to the primary task.

8. The computer-implemented method of claim 7, further comprising:
generating, by the computer, the context-dependent task resumption memory cue personalized to the user at the start of the task interruption lag period corresponding to the primary task based on the context of the primary task in response to the computer estimating the start and the duration of the task interruption lag period corresponding to the primary task.

9. The computer-implemented method of claim 1, wherein the context-dependent task resumption memory cue includes at least one of an audio cue, an animated task summary with visual highlighting, and a list of references corresponding to the primary task, and wherein an audio synthesizer generates the audio cue and a summary animator generates the animated task summary with the visual highlighting.

10. A computer system for context-dependent memory stimulation, the computer system comprising:
a communication fabric;
a storage device connected to the communication fabric, wherein the storage device stores program instructions; and
a processor connected to the communication fabric, wherein the processor executes the program instructions to:
send a context-dependent task resumption memory cue personalized to a user to a client device of the user via a network during a task interruption lag period corresponding to a primary task prior to the user starting a set of secondary tasks to support a context-dependent memory of the user associated with the primary task;
determine that the user started performing the set of secondary tasks based on monitoring the client device;
determine that the user stopped performing the set of secondary tasks and resumed the primary task based on the monitoring of the client device; and
resend the context-dependent task resumption memory cue personalized to the user to the client device via the network during a task resumption lag period corresponding to the primary task to stimulate the context-dependent memory of the user associated with the primary task in response to determining that the user stopped performing the set of secondary tasks and resumed the primary task.

11. The computer system of claim 10, wherein the processor further executes the program instructions to:
identify resumption of the primary task by the user based on the monitoring of the client device; and
identify a set of quantitative metrics associated with the resumption of the primary task by the user based on the monitoring of the client device.

12. The computer system of claim 11, wherein the processor further executes the program instructions to:
request a set of qualitative metrics as feedback from the user regarding effectiveness of the context-dependent task resumption memory cue personalized to the user in relation to the resumption of the primary task by the user; and
receive the set of qualitative metrics from the client device via the network.

13. The computer system of claim 12, wherein the processor further executes the program instructions to:
perform, using a reinforcement learning model, an analysis of the set of quantitative metrics and the set of qualitative metrics; and
determine, using the reinforcement learning model, effectiveness of the context-dependent task resumption memory cue personalized to the user in relation to the resumption of the primary task by the user based on the analysis of the set of quantitative metrics and the set of qualitative metrics.

14. The computer system of claim 13, wherein the processor further executes the program instructions to:
determine whether the effectiveness of the context-dependent task resumption memory cue personalized to the user is less than a defined minimum effectiveness threshold level; and
adjust, using the reinforcement learning model, an audio synthesizer to optimize generation of an audio cue and a summary animator to optimize generation of an animated task summary with visual highlighting in accordance with the analysis of the set of quantitative metrics and the set of qualitative metrics.

15. A computer program product for context-dependent memory stimulation, the computer program product comprising a computer-readable storage medium having program instructions embodied therewith, the program instructions executable by a computer to cause the computer to:
send a context-dependent task resumption memory cue personalized to a user to a client device of the user via a network during a task interruption lag period corresponding to a primary task prior to the user starting a set of secondary tasks to support a context-dependent memory of the user associated with the primary task;
determine that the user started performing the set of secondary tasks based on monitoring the client device;
determine that the user stopped performing the set of secondary tasks and resumed the primary task based on the monitoring of the client device; and
resend the context-dependent task resumption memory cue personalized to the user to the client device via the network during a task resumption lag period corresponding to the primary task to stimulate the context-dependent memory of the user associated with the primary task in response to determining that the user stopped performing the set of secondary tasks and resumed the primary task.

16. The computer program product of claim 15, wherein the program instructions further cause the computer to:
identify resumption of the primary task by the user based on the monitoring of the client device; and
identify a set of quantitative metrics associated with the resumption of the primary task by the user based on the monitoring of the client device.

17. The computer program product of claim 16, wherein the program instructions further cause the computer to:
request a set of qualitative metrics as feedback from the user regarding effectiveness of the context-dependent task resumption memory cue personalized to the user in relation to the resumption of the primary task by the user; and
receive the set of qualitative metrics from the client device via the network.

18. The computer program product of claim 17, wherein the program instructions further cause the computer to:
perform, using a reinforcement learning model, an analysis of the set of quantitative metrics and the set of qualitative metrics; and
determine, using the reinforcement learning model, effectiveness of the context-dependent task resumption memory cue personalized to the user in relation to the resumption of the primary task by the user based on the analysis of the set of quantitative metrics and the set of qualitative metrics.

19. The computer program product of claim 18, wherein the program instructions further cause the computer to:
determine whether the effectiveness of the context-dependent task resumption memory cue personalized to the user is less than a defined minimum effectiveness threshold level; and
adjust, using the reinforcement learning model, an audio synthesizer to optimize generation of an audio cue and a summary animator to optimize generation of an animated task summary with visual highlighting in accordance with the analysis of the set of quantitative metrics and the set of qualitative metrics.

20. The computer program product of claim 15, wherein the program instructions further cause the computer to:
monitor the client device of the user via the network:
determine that the user is performing the primary task and a context of the primary task based on the monitoring of the client device; and
monitor a task workflow of the primary task on the client device of the user via the network in response to determining that the user is performing the primary task, wherein the task workflow includes entries in an electronic calendar corresponding to the user.
